(19) United States
(12) Patent Application Publication
(10) Pub. No.: US 2014/0149140 A1
(43) Pub. Date: May 29, 2014

(54) SYSTEM AND METHOD FOR PATIENT IDENTIFICATION INDEX

(71) Applicant: PRECISION DYNAMICS CORPORATION, Valencia, CA (US)

(72) Inventor: Rick Ellis, Lexington, MA (US)

(73) Assignee: PRECISION DYNAMICS CORPORATION, Valencia, CA (US)

(21) Appl. No.: 13/687,857

(22) Filed: Nov. 28, 2012

(51) Int. Cl. G06F 19/00

(52) U.S. Cl. CPC G06F 19/327
USPC 705/3

(57) ABSTRACT

A system and process for creating a patient identification index for a patient care environment. The system includes a computer processor and electronic database connected to a network. A data analysis module performs the process. The process includes receiving a plurality of ADT records have patient identifiers corresponding to a respective plurality of patients. The patient identifiers in the ADT records are assigned to a corresponding data field in a reference table, which is continually updated with additional ADT records as they are received. A first ADT record for an identified patient is matched with a second ADT record for the identified patient based upon one or more common patient identifiers from the first and second ADT records.

### BACKGROUND OF THE INVENTION

This invention relates generally to a system and method for a patient identification index. More specifically, a system and method for matching a plurality of patient identification formats with a particular patient and allowing for the integration of such various formats into a single system.

Within the healthcare setting, there are a large number of computerized systems, diagnostic systems and therapy devices. Most of these systems require a patient identifier in order to enable certain data storage, safety, or tracking features within the system. In many cases, the safe and effective use of the device depends on proper entry of the patient's identification.

Recent studies have found that identification errors within these systems are significant. Because there is not a standard in the US for how a patient will be identified, each hospital and device provider is free to choose from any of a number of possible IDs. Any of patient name, bed number, medical record number, episode of care, social security number, date of birth, or any similar identifier, can be used to identify a patient. This practice makes it very difficult to integrate information across multiple systems for use in real time diagnosis and treatment, or use in retrospective analysis for process improvement. The practice also results in a significant number of repeated tests or lost results due to ID errors.

Common causes of data entry error include worn out/stained barcodes, multiple wristband ID formats and/or accounts, scanning barcodes from other hospital facilities, using transient/arbitrary account numbers (e.g. 999-999-999), manually entering identification in an outpatient facility with no access to barcoded wristbands, or selecting of wrong account/episode number when wristbanding a patient. Such errors are likely to result in a delay in the delivery of care and other similar problems.

Accordingly, there is a need for a system and method that facilitates the integration of various forms of patient identification. Furthermore, there is a need for a system and method that minimizes common causes of data entry errors in such patient identification systems. The present invention fulfills these needs and provides other related advantages.

### SUMMARY OF THE INVENTION

The present invention is directed to a system and method that facilitates the integration of various forms of patient identification. The inventive system and method also minimizes common causes of data entry errors in such patient identification systems.

In the present invention, a server on a hospital network is configured to receive and process all Admit Discharge Transfer (ADT) messages that are generated from any system in the hospital. As messages are received, the server stores all messages and builds a reference table that includes fields for all known elements of patient ID used in the hospital. A server application continually checks to match active patients (those who have been admitted but not yet discharged) with known previous patients (those treated and discharged in the past). The server application also checks to match active patients where two or more separate records using different elements/forms of patient ID may have been opened. As matches are made, the records are updated to link all different elements of ID so that the identification problems described above are eliminated.

To create the reference table, each hospital identifies all aspects of ID that are possibly used in the hospital. This will generate the initial list of fields for the database. In addition to the ID attributes, an association with certain assets (equipment), disease states and/or clinicians may also be included.

The present invention is directed to a process for creating a patient identification index for a patient care environment. The process includes the step of receiving a plurality of ADT (Admit Discharge Transfer) records corresponding to a respective plurality of patients in the patient care environment, wherein each ADT record comprises one or more patient identifiers. The ADT records are stored in an electronic database and a reference table having separate data fields for different forms of patient identifiers used in the patient care environment is built. Each ADT record is processed so as to assign each of the patient identifiers to a corresponding one of the data fields in the reference table. The reference table is continually updated with additional ADT records as they are received. A first ADT record for an identified patient is matched with a second ADT record for the identified patient based upon one or more common patient identifiers from the first and second ADT records.

The matching includes matching a first patient identifier from the first ADT record to a second patient identifier from the second ADT record and linking the first patient identifier to the second patient identifier in the reference table. The matching step also includes linking all common patient identifiers from all available ADT records for the identified patient. The patient identifiers include last name, first name, medical record number, accession number, social security number, date of birth, insurance number, in-patient wristband number, or temporary admission number. All forms of patient identifiers used in the patient care environment are preferably listed to assist in building the reference table.

The reference table may also include separate data fields for equipment, disease states, clinicians, or episodes of care. In this case, each ADT record may also include one or more asset identifiers for equipment, disease states, clinicians, or episodes of care. Where asset identifiers are used, the matching step further involves creating an association between the patient identifiers of the first ADT record for the identified patient and one or more asset identifiers for equipment, disease states, clinicians, or episodes of care from a third ADT record for the identified patient.

The matching also includes cross-referencing the first and second ADT records for the identified patient with a fourth ADT record for the identified patient corresponding to a prior admission of the identified patient to the patient care environment.

The matching step also includes calculating a matching score for the one or more common patient identifiers from the first and second ADT records for the identified patient and determining whether the matching score exceeds a predetermined threshold value for a likeliness of match. The matching step also involves identifying conflicts between patient identifiers of the first ADT record for the identified patient and patient identifiers of a fifth ADT record for either the identified patient or another patient.

The present invention is also directed to a system for creating a patient identification index for a patient care environment. The system includes a computer processor and electronic database connected to a network. The computer processor includes a data analysis module and the electronic database includes a reference table. The reference table has separate data fields for different forms of patient identifiers used in the patient care environment. The data analysis module is programmed to receive a plurality of ADT records corresponding to a respective plurality of patients in the patient care environment, wherein each ADT record comprises one or more patient identifiers. The ADT records are stored in the reference table on the electronic database. Each ADT record is processed so as to assign each of the patient identifiers to a corresponding one of the data fields in the reference table. The reference table is continually updated with additional ADT records as they are received. A first ADT record for an identified patient is matched with a second ADT record for the identified patient based upon one or more common patient identifiers from the first and second ADT records.

The data analysis module may also be programmed to match a first patient identifier from the first ADT record to a second patient identifier from the second ADT record and link the first patient identifier to the second patient identifier in the reference table. The data analysis module also matches the first ADT record with the second ADT record by linking all common patient identifiers from all available ADT records for the identified patient. The data analysis module is further programmed to list all forms of patient identifiers used in the patient care environment. The patient identifiers comprise last name, first name, medical record number, accession number, social security number, date of birth, insurance number, in-patient wristband number, or temporary admission number.

The reference table also includes separate data fields for equipment, disease states, clinicians, or episodes of care, and wherein each ADT record comprises one or more asset identifiers for equipment, disease states, clinicians, or episodes of care. The data analysis module is further programmed to create an association between the patient identifiers of the first ADT record for the identified patient and one or more asset identifiers for equipment, disease states, clinicians, or episodes of care from a third ADT record for the identified patient.

The data analysis module is further programmed to cross-reference the first and second ADT records for the identified patient with a fourth ADT record for the identified patient corresponding to a prior admission of the identified patient to the patient care environment. The data analysis module may also calculate a matching score for the one or more common patient identifiers from the first and second ADT records for the identified patient and determine whether the matching score exceeds a predetermined threshold value for a likeliness of match.

The data analysis module also identifies conflicts between patient identifiers of the first ADT record for the identified patient and patient identifiers of a fifth ADT record for either the identified patient or another patient.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a system diagram illustrating that the ID server is linked with the hospital information system (HIS) as well as various devices by either a wired or wireless network connection;

FIG. 2 is a sample reference table database of active patients;

FIG. 3 is a sample ADT message;

FIG. 4 is another sample ADT message;

FIG. 5 is a sample ADT message resulting in a conflict; and

FIG. 6 is a sample of an ADT inquiry to obtain full ID information.

### DETAILED DESCRIPTION OF THE PREFERRED EMBODIMENTS

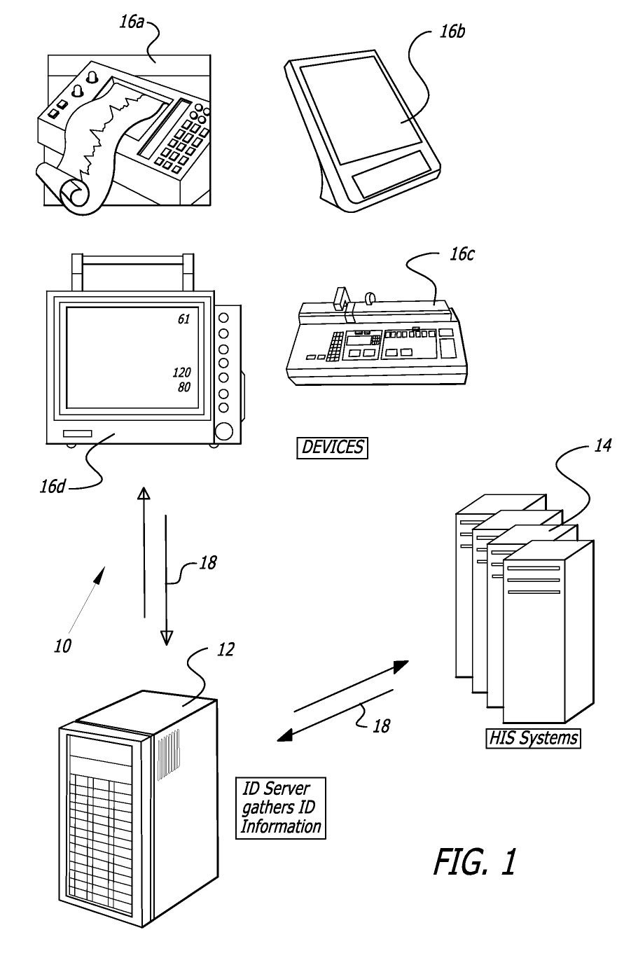

The present invention is concerned with a system and method for a patient identification index. More specifically, a system and method for matching a plurality of patient identification formats with a particular patient and allowing for the integration of such various formats into a single system. FIGS. 1-6 illustrate the system, generally identified by reference number 10, and various elements thereof.

FIG. 1 is a diagram illustrating the system 10 of the present invention having an ID server 12 which gathers identification information for the various patients. This ID server 12 is linked with both the hospital information system (HIS) 14 and various medical and recording devices 16a, 16b, 16c, 16d in the facility. Such link 18 is either achieved by direct wired or wireless network connection to the ID server 12.

In a preferred embodiment, the server 12 on a hospital network 10 is configured to receive and process all Admit Discharge Transfer (ADT) messages 20 that are generated from any system in the hospital. Such ADT messages 20 are well established in the industry and are preferably formatted according to the HL7 standard for data interchange.

As messages 20 are received, the server 12 stores all messages 20 and builds a reference table 22 that includes fields for all known elements of patient ID used in the hospital. A server application continually checks to match active patients (those who have been admitted but not yet discharged) with known previous patients (those treated and discharged in the past). The server application also checks to match active patients where two or more separate records using different elements/forms of patient ID may have been opened. As matches are made, the records are updated to link all different elements of ID so that the identification problems described above are eliminated.

To create the reference table 22, each hospital will identify all aspects of ID that are possibly used in the hospital. This will generate the initial list of fields for the database. In addition to the ID attributes, an association with certain assets (equipment), disease states and/or clinicians may also be included.

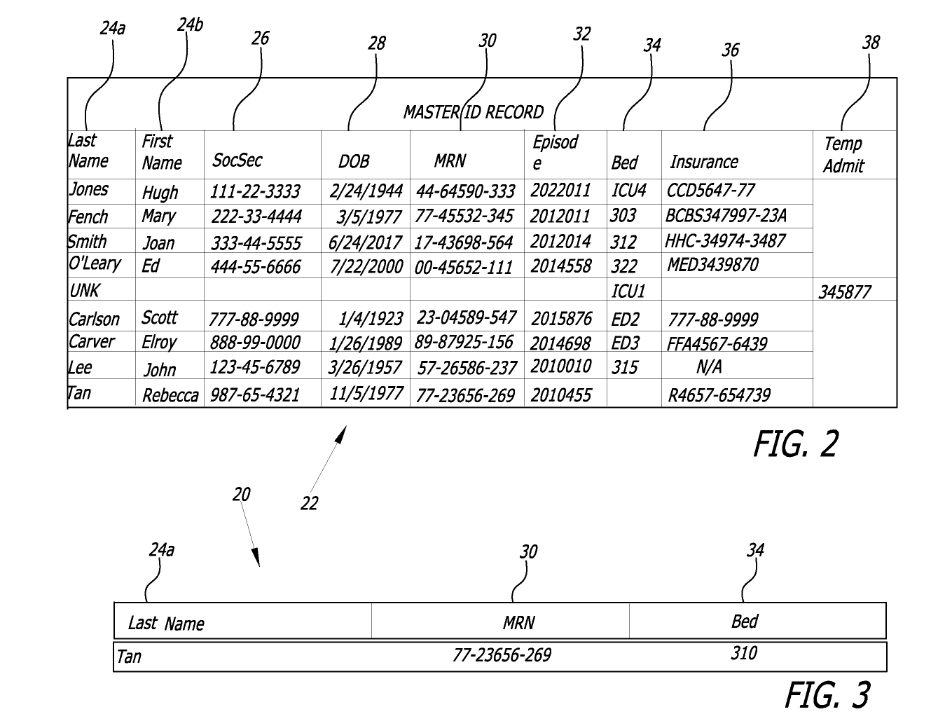

FIG. 2 is a sample reference table or database 22 of active patients. This sample database 22 includes fields for last name 24a, first name 24b, social security number 26, date of birth 28, medical record number 30, episode 32, bed number 34, insurance information 36, and temporary admit number 38. This database 22 may include different or additional fields depending upon the various ID aspects that are used in the hospital. One example of an additional field in the reference table 22 is a Medical Device (not shown) field. This Medical Device field would identify a particular machine or device that was used by or on a particular patient. An entry under this field of the reference table 22 would create an association between the patient and each unique Medical Device used by or on the patient. Such an association achieves several purposes. First, a medical facility could verify that a patient was billed for a particular procedure. An algorithm would scan all equipment associated with the patient and cross-reference those associations with patient billings to confirm that a patient had been billed for each procedure performed by each device. Second, a medical facility could use this association to determine whether a particular patient had been in contact with a defective (in the case of a recall or similar event) or contaminated (in the case of an infectious outbreak) device. The Medical Device field association also fulfills other related and similar purposes. Ideally, all fields for a particular patient are filled in as completely as possible at the time of admission so as to avoid misidentification and to minimize patient identification conflicts.

FIG. 3 illustrates an ADT message 20 associating a bed number 34 with a particular patient name 24a, 24b. In this case, the last name 24a of the patient is “Tan” and the MRN number 30 is “77-23656-269”. Correlating this ADT message 20 with the master ID record illustrated in FIG. 2, the database 22 would be updated to show “Rebecca Tan's” bed number 34 as “310”. When an ADT message 20 is received it is compared to the active patient roster to see if any new information is provided that should be added to the master ID record.

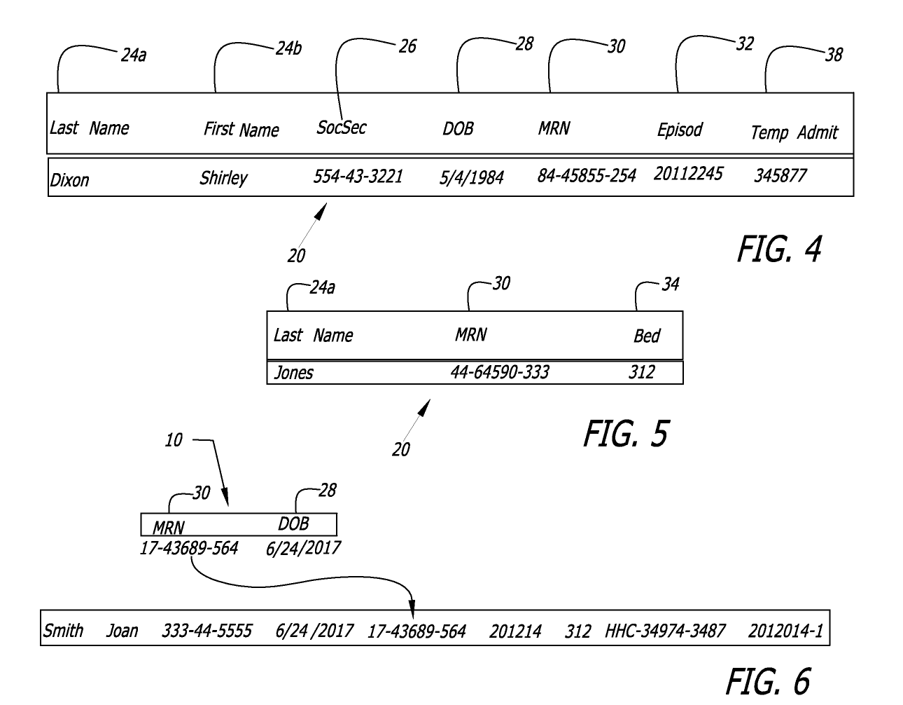

FIG. 4 illustrates another ADT message 20 supplying multiple ID fields for a previously unknown patient. Comparing to FIG. 2, the unknown patient in “ICU1” was provided “345877” as a temporary admission number 38. The system would compare that temporary admission number to the master ID record and associate all of the new ID information with the unknown patient in “ICU1”. The master ID record would be updated accordingly.

FIG. 5 is another ADT message 20 indicating that patient “Jones” has been moved to bed “312”. However, according to the master ID record, patient “Smith” is already in bed “312”. In this case, the system 12 would recognize that patient “Jones” had been discharged from “ICU4” and moved to bed “312”. Patient “Smith”, who had been in bed “312”, would be moved to an unknown bed number and a message sent to the unit manager for correction.

The same server 12 also provides a look-up capability for all systems in the hospital so that identification of a patient can be verified prior to use by one of those systems. Additional ID and demographic information may also be supplied. For example, prior to an EKG test the EKG machine would send the patient name that had been entered. The server 12 would verify that the name corresponded to a valid active patient and could return both the validation and additional information about the patient such as date of birth 28 or Insurance information 36.

In FIG. 6, a sample order 40 to a cardiology tech to perform an EKG on a particular patient would result in an inquiry to the ID system 12 based upon an MRN number 30 and/or date of birth 28. The ID system 12 would identify patient Smith and all corresponding ID fields and provide the full ID information to the cardiology tech for automatic entry into the EKG machine. If a request for identification is received from an invalid patient identifier, the user would be notified and could resolve the issue prior to the test being performed.

A partial list of the types of devices that might query for Patient ID Info include:
Cardiograph;
Diagnostic Imaging Machine;
Sequential Compression Device;
EEG Machine;
EKG Machine;
Warmer;
Glucometer;
Ventilator;
Fall Prevention System;
Enteral Feeding Device;
Patient Monitor;
Infusion Pump;
Wander Management System;
Incubator.

The server would also have the ability to scan previously discharged patients in order to gather and populate missing data. The data could be automatically updated or alternately presented to a person for validation.

Intelligent algorithms enable the server to calculate a score for the “likeliness of match” based on data elements that are available. Scores above a certain threshold cause the server 12 to automatically update ID data while lower scores will cause the data to be presented to a human for validation.

Several known algorithms that can accomplish this calculation include the Boyer-Moore string search algorithm, the Knuth-Morris-Pratt string search algorithm and the Rabin-Karp string search algorithm. Boyer-Moore searches a string of data for a pattern in the data by using information gathered during a pre-search step to skip section of data that do not fit the pattern. This functionality results in a lower constant factor compared to other string algorithms. Knuth-Morris-Pratt searches for occurrences of a particular word in a main text string by observing when a mismatch occurs to determine where the next match could begin. This allows the algorithm to skip re-examination of previously matched characters. Rabin-Karp uses hashing (mapping large data sets of variable length to smaller data sets of fixed length) to find any one of a set of pattern strings in a text.

Each of these algorithms or any other that is used can be augmented by domain knowledge in the priority and weighting of certain factors. Such factors include a medical record number being given the highest weight followed by episode number or accession number. Other factors such as last name, first name, and date of birth would be indicators but not certain identifiers in the algorithm. Room and bed numbers would be the lowest level weight since they can be more easily changed than any of the other factors. The system includes tools and configurations that would allow each patient care environment to configure the priority and weighting of the algorithms.

Although several embodiments have been described in detail for purposes of illustration, various modifications may be made without departing from the scope and spirit of the invention. Accordingly, the invention is not to be limited, except as by the appended claims.

What is claimed is:

1. A process for creating a patient identification index for a patient care environment, comprising the steps of:
receiving a plurality of ADT (Admit Discharge Transfer) records corresponding to a respective plurality of patients in the patient care environment, wherein each ADT record comprises one or more patient identifiers;
storing the ADT records in an electronic database;
building a reference table having separate data fields for different forms of patient identifiers used in the patient care environment;
processing each ADT record so as to assign each of the patient identifiers to a corresponding one of the data fields in the reference table;
continually updating the reference table with additional ADT records as they are received; and
matching a first ADT record for an identified patient with a second ADT record for the identified patient based upon one or more common patient identifiers from the first and second ADT records.

2. The process of claim 1, wherein the matching step comprises the steps of:
matching a first patient identifier from the first ADT record to a second patient identifier from the second ADT record; and
linking the first patient identifier to the second patient identifier in the reference table.

3. The process of claim 1, wherein the matching step comprises linking all common patient identifiers from all available ADT records for the identified patient.

4. The process of claim 1, 2 or 3, wherein the reference table includes separate data fields for equipment, disease states, clinicians, or episodes of care, and wherein each ADT record comprises one or more asset identifiers for equipment, disease states, clinicians, or episodes of care.

5. The process of claim 4, wherein the matching step further comprises creating an association between the patient identifiers of the first ADT record for the identified patient and one or more asset identifiers for equipment, disease states, clinicians, or episodes of care from a third ADT record for the identified patient.

6. The process of claim 1, 2 or 3, wherein the patient identifiers comprise last name, first name, medical record number, accession number, social security number, date of birth, insurance number, in-patient wristband number, or temporary admission number.

7. The process of claim 1, further comprising the step of listing all forms of patient identifiers used in the patient care environment.

8. The process of claim 1, 2, 3 or 7, wherein the matching step further comprises cross-referencing the first and second ADT records for the identified patient with a fourth ADT record for the identified patient corresponding to a prior admission of the identified patient to the patient care environment.

9. The process of claim 1, 2, 3 or 7, wherein the matching step further comprises the steps of:
calculating a matching score for the one or more common patient identifiers from the first and second ADT records for the identified patient; and
determining whether the matching score exceeds a predetermined threshold value for a likeliness of match.

10. The process of claim 1, 2, 3 or 7, wherein the matching step comprises identifying conflicts between patient identifiers of the first ADT record for the identified patient and patient identifiers of a fifth ADT record for either the identified patient or another patient.

11. A system for creating a patient identification index for a patient care environment, comprising:
a computer processor and electronic database connected to a network, wherein the computer processor includes a data analysis module and the electronic database includes a reference table;
the reference table having separate data fields for different forms of patient identifiers used in the patient care environment; and
the data analysis module programmed to:
receive a plurality of ADT records corresponding to a respective plurality of patients in the patient care environment, wherein each ADT record comprises one or more patient identifiers;
store the ADT records in the reference table;
process each ADT record so as to assign each of the patient identifiers to a corresponding one of the data fields in the reference table;
continually update the reference table with additional ADT records as they are received; and
match a first ADT record for an identified patient with a second ADT record for the identified patient based upon one or more common patient identifiers from the first and second ADT records.

12. The system of claim 11, wherein the data analysis module is further programmed to match a first patient identifier from the first ADT record to a second patient identifier from the second ADT record; and link the first patient identifier to the second patient identifier in the reference table.

13. The system of claim 11, wherein the data analysis module matches the first ADT record with the second ADT record by linking all common patient identifiers from all available ADT records for the identified patient.

14. The system of claim 11, 12 or 13, wherein the reference table includes separate data fields for equipment, disease states, clinicians, or episodes of care, and wherein each ADT record comprises one or more asset identifiers for equipment, disease states, clinicians, or episodes of care.

15. The system of claim 14, wherein the data analysis module is further programmed to create an association between the patient identifiers of the first ADT record for the identified patient and one or more asset identifiers for equipment, disease states, clinicians, or episodes of care from a third ADT record for the identified patient.

16. The system of claim 11, 12 or 13, wherein the patient identifiers comprise last name, first name, medical record number, accession number, social security number, date of birth, insurance number, in-patient wristband number, or temporary admission number.

17. The system of claim 11, wherein the data analysis module is further programmed to list all forms of patient identifiers used in the patient care environment.

18. The system of claim 11, 12, 13 or 17, wherein the data analysis module is further programmed to cross-reference the first and second ADT records for the identified patient with a fourth ADT record for the identified patient corresponding to a prior admission of the identified patient to the patient care environment.

19. The system of claim 11, 12, 13 or 17, wherein the data analysis module is further programmed to:
calculate a matching score for the one or more common patient identifiers from the first and second ADT records for the identified patient; and
determine whether the matching score exceeds a predetermined threshold value for a likeliness of match.

20. The process of claim 11, 12, 13 or 17, wherein the data analysis module is further programmed to identify conflicts between patient identifiers of the first ADT record for the identified patient and patient identifiers of a fifth ADT record for either the identified patient or another patient.
